(19) United States
(12) Patent Application Publication
(10) Pub. No.: US 2025/0130390 A1
(43) Pub. Date: Apr. 24, 2025

(54) LENS BARREL AND IMAGE CAPTURING APPARATUS

(71) Applicant: CANON KABUSHIKI KAISHA, Tokyo (JP)

(72) Inventor: SHINICHIRO HARADA, Kanagawa (JP)

(21) Appl. No.: 18/829,886

(22) Filed: Sep. 10, 2024

(30) Foreign Application Priority Data
Oct. 18, 2023 (JP) 2023-179364

(51) Int. Cl. G02B 7/02

(52) U.S. Cl. CPC G02B 7/021

(57) ABSTRACT

A lens barrel capable of high-precision lens holding while achieving miniaturization, the lens barrel including a first lens and a second lens, a first lens frame that holds the first lens and a second lens frame that holds the second lens, and a first guide bar that supports the first lens frame so that it is movable in an optical axis direction, in which the first lens frame includes a sleeve portion including a first hole portion and a second hole portion that are engaged with the first guide bar and an opening portion formed between the first hole portion and the second hole portion, the second lens frame is provided with a third hole portion that engages with the first guide bar, and when the first guide bar is engaged with the first hole portion and the second hole portion of the first lens frame and the third hole portion of the second lens frame, the first lens frame and the second lens frame are positioned in a direction perpendicular to the optical axis by the first guide bar, and the third hole portion of the second lens frame is disposed within the opening of the sleeve portion.

### BACKGROUND OF THE INVENTION

### Field of the Invention

The present invention relates to a lens barrel and an image capturing apparatus.

### Description of the Related Art

In the related art, in order to realize high-quality zoom lenses, there is known a configuration in which a fixed lens for compensating for imaging performance by refracting light is provided in addition to a movable zoom lens and a focus lens. In addition, generally, a lens frame that holds the fixed lens may have a hole for positioning it with respect to a housing, and the hole may first engage with a positioning boss provided on the housing, thereby positioning a fixed lens frame.

However, in the case of such a positioning structure, a space for the positioning boss provided in the housing is required, which makes the overall size of the lens barrel larger. On the other hand, to achieve high image quality, it is preferable to reduce a relative positional deviation between the center of the fixed lens and the center of the zoom lens, that is, to hold the lenses with high precision. However, when the fixed lens frame is positioned by the positioning boss provided in the housing, the positioning structure is different from that of the zoom lens that is movable while being positioned by engaging with a guide bar, and thus a relative positional deviation is likely to occur between the centers of the two lenses.

Japanese Patent Application Laid-Open No. 2014-006465 discloses a configuration in which, when a lens holding frame is inserted into a drive head side of a drive motor, a position detection pulse plate attached to a screw part of the drive motor and the lens holding frame overlap each other in the radial direction. In addition, Japanese Patent Application Laid-Open No. 2018-180322 discloses a configuration in which a notch is provided in the exterior of an aperture unit so that a part of a lens drive motor head part is located inside the exterior of the aperture unit.

However, when the related art disclosed in each of Japanese Patent Application Laid-Open No. 2014-006465 and Japanese Patent Application Laid-Open No. 2018-180322 is applied to a lens holding structure that enables high-precision lens holding while achieving miniaturization, it will be difficult to achieve high-precision lens holding, even when miniaturization can be achieved.

### SUMMARY OF THE INVENTION

In view of the above circumstances, an object of the present invention is to provide a lens barrel capable of high-precision lens holding while achieving miniaturization.

A lens barrel according to one aspect of the present invention includes a first lens and a second lens, a first lens frame that holds the first lens and a second lens frame that holds the second lens, and a first guide bar that supports the first lens frame so that it is movable in an optical axis direction, in which the first lens frame includes a sleeve portion including a first hole portion and a second hole portion that are engaged with the first guide bar and an opening portion formed between the first hole portion and the second hole portion, the second lens frame is provided with a third hole portion that engages with the first guide bar, and when the first guide bar is engaged with the first hole portion and the second hole portion of the first lens frame and the third hole portion of the second lens frame, the first lens frame and the second lens frame are positioned in a direction perpendicular to the optical axis by the first guide bar, and the third hole portion of the second lens frame is disposed within the opening of the sleeve portion.

Further features of the present invention will become apparent from the following description of exemplary embodiments with reference to the attached drawings.

### BRIEF DESCRIPTION OF THE DRAWINGS

FIG. 1 is a configuration diagram showing an example of an image capturing apparatus according to an embodiment.

FIG. 2 is an exploded perspective view showing a configuration of a zoom lens barrel according to the embodiment.

FIG. 3 is a block diagram of the image capturing apparatus according to the embodiment.

FIGS. 4A and 4B are diagrams showing details of a movable lens frame and a fixed lens frame according to the embodiment.

FIG. 5 is a detailed view showing the movable lens frame and the fixed lens frame which are engaged with two guide bars.

FIGS. 6A and 6B are diagrams showing a state where a hole part of the fixed lens frame is disposed in an opening of a sleeve portion of the movable lens frame.

FIG. 7 is a diagram showing a state where the fixed lens frame is fastened to a rear fixed frame with screws.

FIGS. 8A and 8B are diagrams showing a state where a zoom position of the movable lens frame is at the WIDE end position.

FIGS. 9A and 9B are diagrams showing the state where the zoom position of the movable lens frame is at the position of a TELE end.

FIGS. 10A and 10B are diagrams showing a state where the two guide bars, the fixed lens frame, the aperture unit, and the movable lens frame are incorporated and then inserted into the rear fixed frame and the fixed lens frame is fastened to the rear fixed frame.

FIG. 11 is a partially enlarged view of the state shown in FIG. 10.

FIGS. 12A and 12B are diagrams showing a state where the rear fixed frame has been removed from the state shown in FIG. 10.

### DESCRIPTION OF THE EMBODIMENTS

Hereinafter, an embodiment for implementing the present invention will be described in detail with reference to the accompanying drawings. The embodiment to be described below is an example of a means for realizing the present invention and should be appropriately modified or changed depending on the configuration of an apparatus to which the present invention is applied and various conditions, and the present invention is not limited to the following embodiment.

### First Embodiment

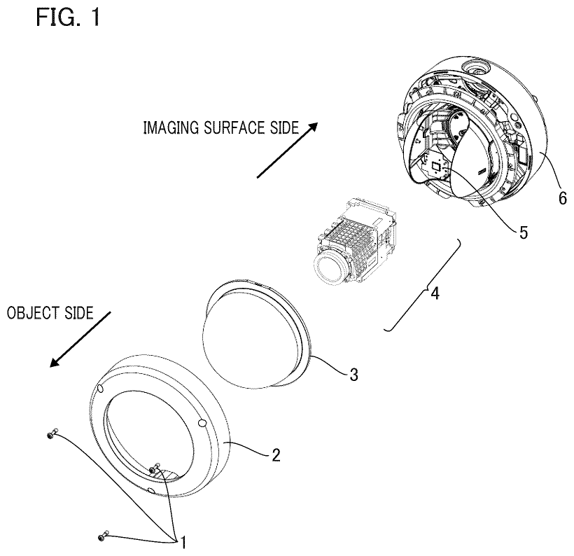

FIG. 1 is a configuration diagram of an image capturing apparatus according to the present embodiment. The image capturing apparatus of the present embodiment is configured to include a cover 2, a dome cover 3, a zoom lens barrel 4, an image sensor unit 5, and a pan-tilt rotation unit 6. In the present embodiment, the image capturing apparatus is configured as a network camera. More specifically, in the present embodiment, the image capturing apparatus is configured as a network monitoring camera.

The image sensor unit 5 holds an image sensor and is attached to the zoom lens barrel 4. The pan-tilt rotation unit 6 holds the zoom lens barrel 4 so that it is rotatable in panning, tilting, and rotation directions. The dome cover 3 is fastened to the image capturing apparatus by a plurality of fastening screws 1 while being sandwiched between the cover 2 and the pan-tilt rotation unit 6.

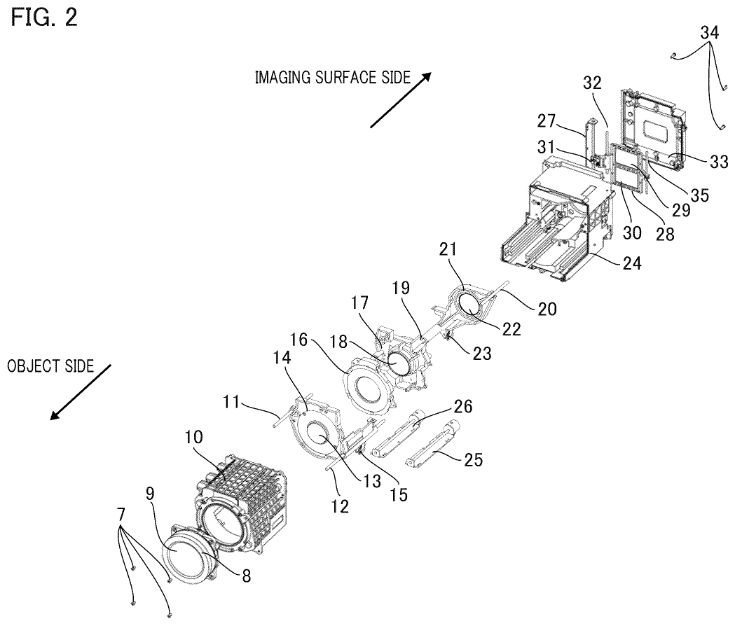

FIG. 2 shows an example of an exploded perspective view of the zoom lens barrel 4 according to the present embodiment. The zoom lens barrel 4 according to the present embodiment has four lens groups. The lens 9 is a fixed group that is fixed (unmoving) in the optical axis direction. A zoom lens (first lens) 13 is a movable lens that moves in the optical axis direction to perform a variable power operation. The focus lens 22 moves in the optical axis direction to perform a focusing operation.

The fixed lens frame 8 is fixed to a front fixed frame (front fixed barrel) 10 by screws 7. The front fixed frame 10 is connected to a rear fixed frame (rear fixed barrel) 24 by screws (not shown).

A guide bar (second guide bar) 11, a guide bar (first guide bar) 12, a guide bar 19, and a guide bar 20 are fixed while being sandwiched between the front fixed frame 10 and the rear fixed frame 24.

A movable lens frame (first lens frame) 14 holds the zoom lens 13 and is supported by the guide bar 12 to be movable in the optical axis direction. A U-shaped groove on the movable lens frame 14 engages with a U-shaped groove on the guide bar 11, thereby regulating the rotation of the movable lens frame 14 around the guide bar 12, that is, around the optical axis.

A rack 15 is fixed to the movable lens frame 14 while being biased in the optical axis direction and rotation direction by a rack spring (not shown). The rack 15 is screwed into a screw part of a stepping motor 25, and moves in the optical axis direction together with the movable lens frame 14 by the rotation of the screw part.

The aperture unit 16 is fixed by screws (not shown) to a fixed lens frame (second lens frame) 17 that holds a fixed lens (second lens) 18, and adjusts the amount of light incident on the zoom lens barrel 4 by changing an aperture diameter to a plurality of states.

The movable lens frame 21 holds a focus lens 22 and is supported by a guide bar 19 to be movable in the optical axis direction. A U-shaped groove on the movable lens frame 21 engages with a U-shaped groove on the guide bar 20, thereby regulating the rotation of the movable lens frame 21 around the guide bar 19, that is, around the optical axis.

A rack 23, which is connected to the movable lens frame 21, is fixed to the movable lens frame 21 while being biased in the optical axis direction and rotation direction by a rack spring (not shown). The rack 23 is screwed into a screw part of a stepping motor 26, and moves in the optical axis direction together with the movable lens frame 21 by the rotation of the screw part.

A filter moving frame 28 holds an infrared cut filter 29 and a glass member 30, and is supported by the guide bar 32 to be movable in the optical axis direction. A U-shaped groove on the filter moving frame 28 engages with a U-shaped groove on the guide bar 35, thereby regulating the rotation of the filter moving frame 28 around the guide bar 32, that is, around the optical axis.

A rack 31, which is connected to the filter moving frame 28, is fixed to the filter moving frame 28 while being biased in the optical axis direction and rotation direction by a rack spring (not shown). The rack 31 is screwed into a screw part of a stepping motor 27, and moves together with the filter moving frame 28 in a direction perpendicular to the optical axis by the rotation of the screw part. By retracting the infrared cut filter 29 from the optical path, it is possible to image a subject even at night.

A sensor holder 33 holds the image sensor unit 5 using a screw (not shown) for an image element, and is fixed to the rear fixed frame 24 by a screw 34.

The origin position of movement of the movable lens frames 14 and 21 in the optical axis direction is detected by a detector such as a photointerrupter (not shown) that is fixed by soldering to a flexible printed circuit (FPC) (not shown). The FPC is connected to the aperture unit 16, the stepping motors 25, 26, and 27, and a photodetector (not shown), and starts up them by electrical conduction.

The photodetector is disposed on a moving area of the movable lens frames 14 and 21. The positions of the movable lens frames 14 and 21 are controlled by the output of the photodetector and the number of drive pulses of the stepping motors 25 and 26. The lenses such as the lens 9, the zoom lens 13, the fixed lens 18, and the focus lens 22 function as imaging lenses.

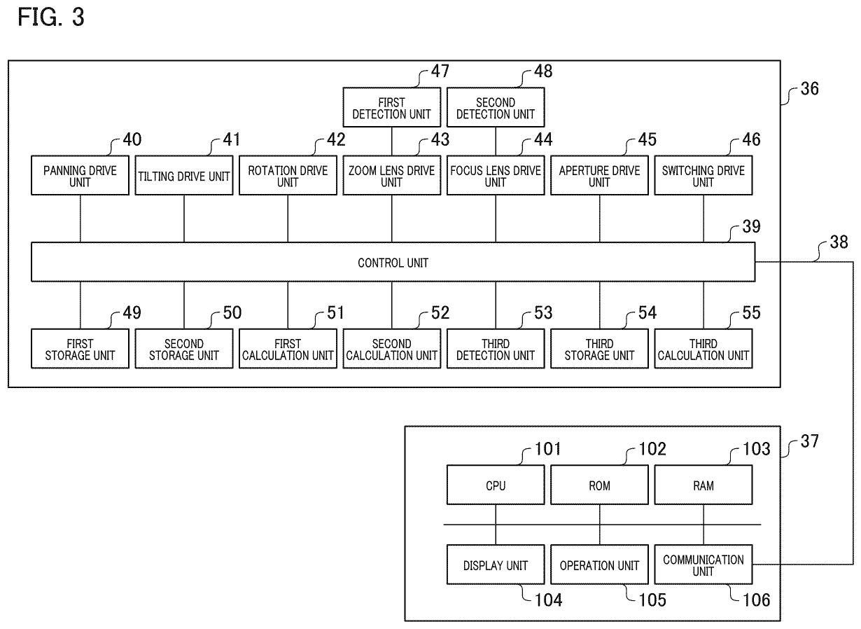

FIG. 3 is a block diagram of the image capturing apparatus in the present embodiment. The image capturing apparatus is constituted by a camera 36 installed outdoors, for example, and an operation unit (information processing device) 37 that operates the camera 36. The camera 36 and the operation unit 37 are connected to each other so that they can communicate with each other via a communication line 38. The camera 36 and the operation unit 37 may also constitute an imaging system.

The camera 36 includes a control unit 39, a panning drive unit 40, a tilting drive unit 41, a rotation drive unit 42, a zoom lens drive unit 43, a focus lens drive unit 44, an aperture drive unit 45, and a switching drive unit 46. The camera 36 also includes a first detection unit 47, a second detection unit 48, a first storage unit 49, a second storage unit 50, a first calculation unit 51, a second calculation unit 52, a third detection unit 53, a third storage unit 54, and a third calculation unit 55.

The control unit 39 includes a CPU, a memory (storage unit), a signal processing unit, and the like and is constituted by at least one computer. The control unit 39 comprehensively controls the operation of the camera 36 and the like in accordance with a program stored in the memory. Specifically, the control unit 39 controls panning, tilting, rotation, and the like in the camera 36 in accordance with a control signal (control command) output (transmitted) in response to the operation (input) from the operation unit 37. The number of CPUs and the number of memories included in the control unit 39 are not limited to one, and may be two or more.

The panning drive unit 40 controls the imaging direction of the camera 36 (panning control). The panning drive unit 40 is connected to the control unit 39. The panning drive unit 40 includes a drive mechanism such as a motor and a speed reduction mechanism. The panning drive unit 40 changes the direction (imaging direction) of the camera 36 (changes the posture) by driving of the drive mechanism based on a control signal (control command) output in response to an operation from the operation unit 37 and received via the control unit 39. The imaging direction that can be changed by the panning drive unit 40 is a panning direction (horizontal direction). The panning drive unit 40 also includes a sensor capable of angle detection. The sensor also functions as a panning angle detection unit that detects a panning angle of the camera 36. Detection results detected by the sensor of the panning drive unit 40 are transmitted to the control unit 39.

The tilting drive unit 41 controls the imaging direction of the camera 36 (tilting control). The tilting drive unit 41 is connected to the control unit 39. The tilting drive unit 41 is equipped with a drive mechanism such as a motor and a speed reduction mechanism. The tilting drive unit 41 changes the direction (imaging direction) of the camera 36 (changes the posture) by driving of the drive mechanism based on a control signal (control command) output in response to an operation from the operation unit 37 and received via the control unit 39. The imaging direction that can be changed by the panning drive unit 40 is a tilting direction (vertical direction). The tilting drive unit 41 also includes a sensor capable of angle detection. The sensor also functions as a tilting angle detection unit that detects a tilting angle of the camera 36. Detection results detected by the sensor of the tilting drive unit 41 are transmitted to the control unit 39.

The rotation drive unit 42 controls the imaging direction of the camera 36 (rotation control). The rotation drive unit 42 is connected to the control unit 39. The rotation drive unit 42 is equipped with a drive mechanism such as a motor and a speed reduction mechanism. The rotation drive unit 42 changes the direction (imaging direction) of the camera 36 (changes the posture) by driving of the drive mechanism based on a control signal (control command) output in response to an operation from the operation unit 37 and received via the control unit 39. The imaging direction that can be changed by the panning drive unit 40 is a rotation direction. The rotation drive unit 42 also includes a sensor capable of angle detection. This sensor also functions as a rotation angle detection unit that detects a rotation angle of the camera 36. Detection results detected by the sensor of the rotation drive unit 42 are transmitted to the control unit 39.

The zoom lens drive unit 43 controls the position of the zoom lens 13 by moving the movable lens frame 14 holding the zoom lens 13 in the optical axis direction. The zoom lens drive unit 43 is constituted by a driving mechanism such as a stepping motor, and the stepping motor 25 functions as the zoom lens drive unit 43 in the present embodiment. The zoom lens drive unit 43 is connected to the control unit 39. The zoom lens drive unit 43 changes the position of the zoom lens by driving of the stepping motor 25 based on a control signal (control command) output in response to an operation from the operation unit 37 and received via the control unit 39. The zoom lens drive unit 43 also includes a first detection unit 47. The first detection unit 47 detects the number of driving pulses of the stepping motor 25. Detection results detected by the first detection unit 47 are transmitted to the control unit 39.

The focus lens drive unit 44 controls the position of the focus lens 22 by moving the movable lens frame 21 holding the focus lens 22 in the optical axis direction. The focus lens drive unit 44 is constituted by a driving mechanism such as a stepping motor, and the stepping motor 26 functions as a focus lens drive unit 44 in the present embodiment. The focus lens drive unit 44 is connected to the control unit 39. The focus lens drive unit 44 changes the position of the focus lens by driving of the stepping motor 26 based on a control signal (control command) output in response to an operation from the operation unit 37 and received via the control unit 39. The zoom lens drive unit 43 also includes a second detection unit 48. The second detection unit 48 detects the number of drive pulses of the stepping motor 26. Detection results detected by the second detection unit 48 are also transmitted to the control unit 39.

The aperture drive unit 45 adjusts the amount of light incident on the zoom lens barrel 4 by changing an aperture diameter to a plurality of states. In the present embodiment, the aperture unit 16 functions as the aperture drive unit 45.

The switching drive unit 46 controls switching between the infrared cut filter 29 and the glass member 30. The switching drive unit 46 is connected to the control unit 39. The switching drive unit 46 switches between the infrared cut filter 29 and the glass member 30 by driving a drive mechanism (not shown) based on a control signal (control command) output in response to an operation from the operation unit 37 and received via the control unit 39. The switching drive unit 46 also includes a detection unit constituted by a sensor or the like that detects the position of the filter moving frame 28 that holds the infrared cut filter 29. Detection results detected by the detection unit are transmitted to the control unit 39.

The first storage unit 49 stores the number of drive pulses of the stepping motor 25. The first storage unit 49 is connected to the control unit 39. The second storage unit 50 stores the number of drive pulses of the stepping motor 26. The second storage unit 50 is connected to the control unit 39. The control unit 39 can also read information stored in the first storage unit 49 and the second storage unit 50 at any time.

The first calculation unit 51 calculates the number of drive pulses of the zoom lens drive unit 43 to drive to a predetermined position based on the detection result obtained by the first detection unit 47 and the number of drive pulses of the stepping motor 25 stored in the first storage unit 49. The first calculation unit 51 is connected to the control unit 39. The second calculation unit 52 calculates the number of drive pulses of the focus lens drive unit 44 to drive to a predetermined position based on the detection result obtained by the second detection unit 48 and the number of drive pulses of the stepping motor 26 stored in the second storage unit 50. The second calculation unit 52 is connected to the control unit 39.

The third detection unit 53 detects a drive arm position from a brightness difference of the aperture. The third detection unit 53 is connected to the control unit 39. The third storage unit 54 stores a preset rotation angle position of a drive arm. The third storage unit 54 is connected to the control unit 39. The third calculation unit 55 calculates a difference based on the detection result of the drive arm position detected by the third detection unit 53 and the rotation angle position of the drive arm stored in the third storage unit 54. The third calculation unit 55 is connected to the control unit 39.

Based on the calculation results of the third calculation unit 55, the control unit 39 causes the aperture drive unit 45 to drive aperture blades held by the drive arm, so that an optimal amount of light is incident on the image sensor in the image sensor unit 5.

The operation unit 37 includes a CPU 101, a ROM 102, a RAM 103, a display unit 104, an operation unit 105, and a communication unit 106.

The CPU 101 is a central processing unit that reads out control programs stored in the read-only memory (ROM) 102 and executes various processes. The ROM 102 is a non-volatile memory that stores programs of the camera 36 and the operation unit 37, other programs (control programs) required for control, and various data.

The random access memory (RAM) 103 is a volatile memory and is used as a main memory and a temporary storage area such as a work area of the CPU 101. The RAM 103 also temporarily stores various data such as images and video data. The display unit 104 is constituted by a display device such as a monitor or a display, and displays, for example, images and videos captured by the camera 36.

The operation unit 105 is constituted by an input device such as a keyboard and a mouse. By operating the operation unit 105, it is possible to give instructions for panning, tilting, and rotation operations of the camera 36, the opening and closing of the aperture blades in the aperture unit 16, and the switching of the infrared cut filter. An operator can operate the operation unit 105 to image a subject at a desired magnification while confirming a video captured by the camera 36 on a screen of the display unit 104, and can display the imaged subject on the display unit 104. The communication unit 106 performs communication processing such as transmission of control signals (control commands) to the camera 36 via a network in a wired or wireless manner.

Although not shown in the drawing, the operation unit 37 includes a storage device (storage). The storage device stores various data, various programs, and the like. The storage device is a non-volatile storage device such as a HDD, a flash memory, or an SD card. The storage device is used as a permanent storage area for an OS, various programs, and various data, and is also used as a short-term storage area for various data.

The functions and processing of the camera 36 and the operation unit 37 are realized by the CPU 101 reading out a program stored in the ROM 102 or the storage device and executing the program. As another example, the CPU 101 may read out a program stored in a recording medium such as an SD card instead of the ROM 102.

In the present embodiment, the operation unit 37 executes each processing of the camera 36 and the operation unit 37 by causing one processor (CPU 101) to use one memory (ROM 102), but other configurations may also be adopted. For example, processes of the camera 36 and the operation unit 37 can also be executed by operating a plurality of processors, a plurality of RAMs, ROMs, and storage devices in cooperation. In addition, some processes may be executed using a hardware circuit. Further, functions and processes of the image capturing apparatus may be realized using a processor other than a CPU. In addition, for example, a graphics processing unit may be used instead of a CPU.

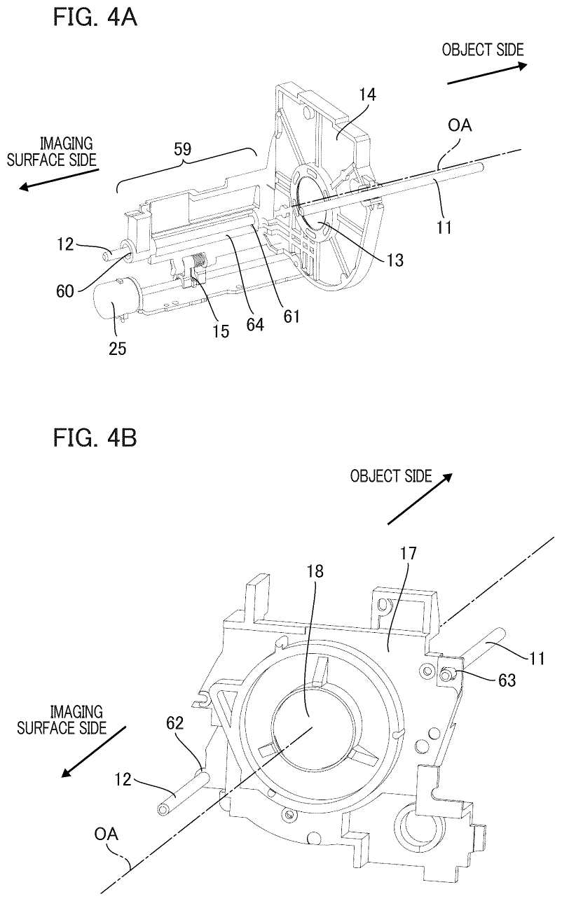

FIG. 4 is a diagram showing an example of details of the movable lens frame 14 and the fixed lens 18. FIG. 4A is a diagram showing an example of details of the movable lens frame 14 that holds the zoom lens 13 as viewed from an imaging surface side (image sensor side). The movable lens frame 14 in the present embodiment includes a sleeve portion 59 for engaging with the guide bar 12.

A first hole portion 60 and a second hole portion 61 for engaging with the guide bar 12 are provided on the side of the sleeve portion 59. The first hole portion 60 is provided toward an imaging surface side of the sleeve portion 59, and the second hole portion 61 is provided toward an object side of the sleeve portion 59. Furthermore, the sleeve portion 59 has an opening 64 between the first hole portion 60 and the second hole portion 61. The opening 64 is an opening portion of the sleeve portion 59 formed between the first hole portion 60 and the second hole portion 61 when viewed from the inside in a direction perpendicular to an optical axis OA.

The sleeve portion 59 is connected to the rack 15 and is screwed thereto using a screw portion (not shown) of the stepping motor 25, and thus it is possible to move the zoom lens 13 straight in the direction of the optical axis OA.

FIG. 4B is a detailed view of the fixed lens frame 17 that holds the fixed lens 18 as viewed from an imaging surface side. The fixed lens frame 17 includes a hole portion (third hole portion) 62 for engaging with the guide bar 12, and an elongated hole portion (fourth hole portion) 63 for engaging with the guide bar 11. The hole portion 62 can regulate the position of the fixed lens frame 17 in a vertical plane (in a plane perpendicular to the optical axis OA) with respect to the optical axis OA. The elongated hole portion 63 is provided to regulate the rotation direction of the fixed lens frame 17 with respect to the optical axis OA.

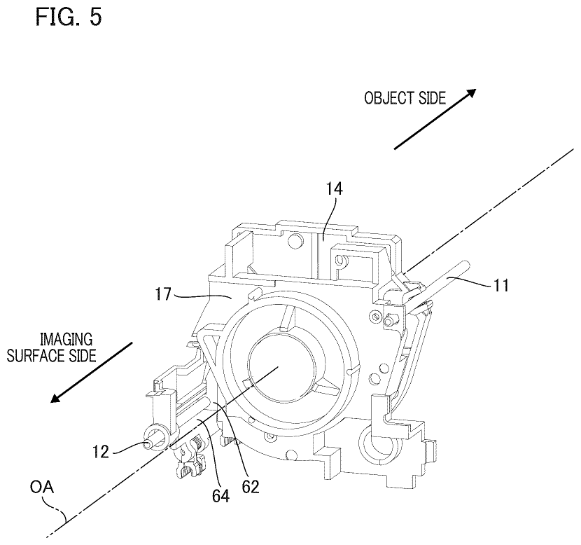

FIG. 5 is a detailed view showing a state where the movable lens frame 14 and the fixed lens frame 17 are engaged with each other at the same time by the guide bar 11 and the guide bar 12. FIG. 5 is also a perspective view showing a state where the movable lens frame 14 and the fixed lens frame 17 are engaged with each other at the same time by the guide bar 11 and the guide bar 12 as viewed from an imaging surface side.

As shown in FIG. 5, the movable lens frame 14 and the fixed lens frame 17 are engaged with each other by the guide bar 11 and the guide bar 12, and thus the hole portion 62 of the fixed lens frame 17 is incorporated into an opening 64 provided in the sleeve portion 59 (the hole portion 62 fits into the opening 64). Then, the guide bar 12 is engaged with the movable lens frame 14 and the fixed lens frame 17, and thus two lens frames (the movable lens frame 14, the fixed lens frame 17) are simultaneously positioned in a plane perpendicular to the optical axis OA or in a direction perpendicular to the optical axis with the guide bar 12 as a reference. Engaging the guide bar 12 with the movable lens frame 14 and the fixed lens frame 17 indicates a state where the guide bar 12 is engaged with each of the first hole portion 60 and the second hole portion 61 of the movable lens frame 14 and the hole portion 62 of the fixed lens frame 17.

Similarly to the guide bar 12, the guide bar 11 is engaged with the movable lens frame 14 and the fixed lens frame 17, and thus the rotation (rotational position) of the two lens frames around the optical axis is regulated in a plane perpendicular to the optical axis OA or in a direction perpendicular to the optical axis. That is, the movable lens frame 14 and the fixed lens frame 17 are positioned by the guide bar 11 in a state where the rotation around the optical axis OA is regulated by the guide bar 11. Engaging the guide bar 11 with the movable lens frame 14 and the fixed lens frame 17 indicates a state where the U-shaped groove on the guide bar 11 is engaged with the U-shaped groove on the movable lens frame 14, and the guide bar 11 is engaged with the elongated hole portion 63 of the fixed lens frame.

Furthermore, the guide bar 11 and the guide bar 12 are engaged with the movable lens frame 14 and the fixed lens frame 17, and thus the hole portion 62 of the fixed lens frame 17 is arranged (disposed) in the opening 64 (within the opening) of the sleeve portion 59.

Then, the guide bar 11 and the guide bar 12 are engaged with the movable lens frame 14 and the fixed lens frame 17, and thus the first hole portion 60 and the second hole portion 61 of the sleeve portion 59 and the hole portion 62 of the fixed lens frame 17 are disposed to overlap each other when viewed from the direction of the optical axis OA. For this reason, both the movable lens frame 14 and the fixed lens frame 17 are positioned by the same guide bar (guide bar 12). With this configuration, it is possible to reduce the exterior of the zoom lens barrel 4 in the radial direction (the direction perpendicular to the optical axis).

Since both the movable lens frame 14 and the fixed lens frame 17 are positioned by the same guide bar (guide bar 12), it is possible to reduce a relative positional deviation with respect to the center of the zoom lens 13 and the center of the fixed lens 18. Thereby, it is possible to improve the accuracy of eccentricity, which is important for high image quality.

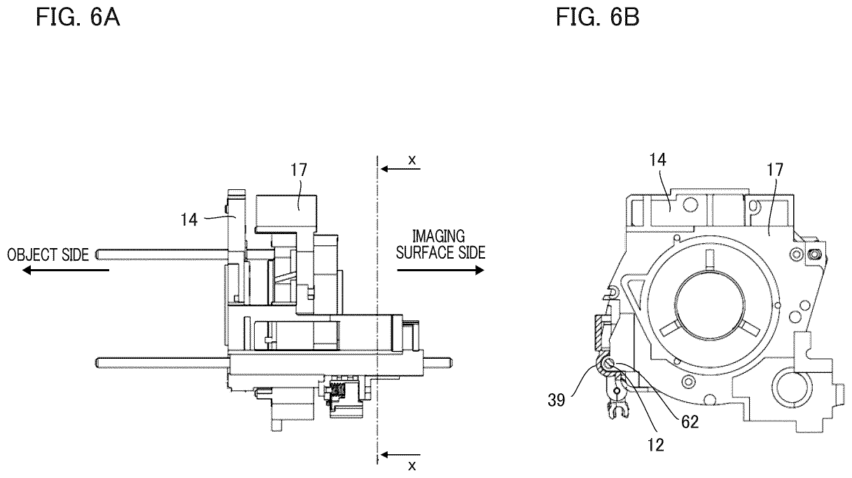

FIG. 6 is a diagram showing a state where the hole portion 62 of the fixed lens frame 17 is disposed in the opening 64 of the sleeve portion 59 of the movable lens frame 14. FIG. 6A is a side view showing a state where the hole portion 62 of the fixed lens frame 17 is disposed in the opening 64 of the sleeve portion 59 of the movable lens frame 14. FIG. 6B is a cross-sectional view taken along a line X-X in FIG. 6A, and is a diagram of the movable lens frame 14 viewed from an imaging surface side in the state of FIG. 6A. Specifically, FIG. 6B is a diagram (front view) showing a state where the hole portion 62 of the fixed lens frame 17 is incorporated into the opening 64 of the sleeve portion 59 of the movable lens frame 14 when viewed from the imaging surface side to an object side in the direction of the optical axis OA.

In this manner, in the present embodiment, the hole portion 62 of the fixed lens frame 17 is engaged with the guide bar 12 while securing clearance from the sleeve portion 59 not to interfere with the sleeve portion 59 of the movable lens frame 14.

For this reason, even when the movable lens frame 14 moves in the direction of the optical axis OA, the movable lens frame 14 can move not to interfere with the fixed lens frame 17. In this manner, in the present embodiment, the positions of the zoom lens 13 and the movable lens frame 14 that change a zoom magnification can be changed with a small relative positional deviation, and thus a high-image-quality zoom lens can be realized.

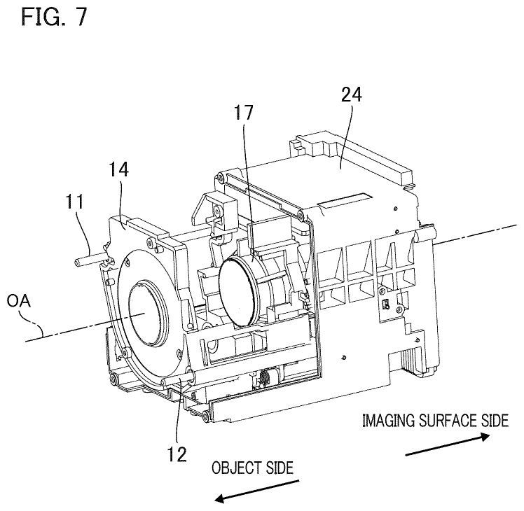

FIG. 7 is a diagram showing a state where the fixed lens frame 17 is fastened to the rear fixed frame 24 with screws (not shown). Specifically, the diagram shows a state where the hole portion 62 of the fixed lens frame 17 is incorporated into the opening 64 of the sleeve portion 59 of the movable lens frame 14. Furthermore, the diagram shows a state where a lens assembly engaged with the guide bar 11 and the guide bar 12 is further incorporated into the rear fixed frame 24, and the fixed lens frame 17 is fastened to the rear fixed frame 24 with screws (not shown).

In this manner, the fixed lens frame 17 is held at a fixed position with respect to the rear fixed frame 24, but the movable lens frame 14 is movable in the direction of the optical axis OA.

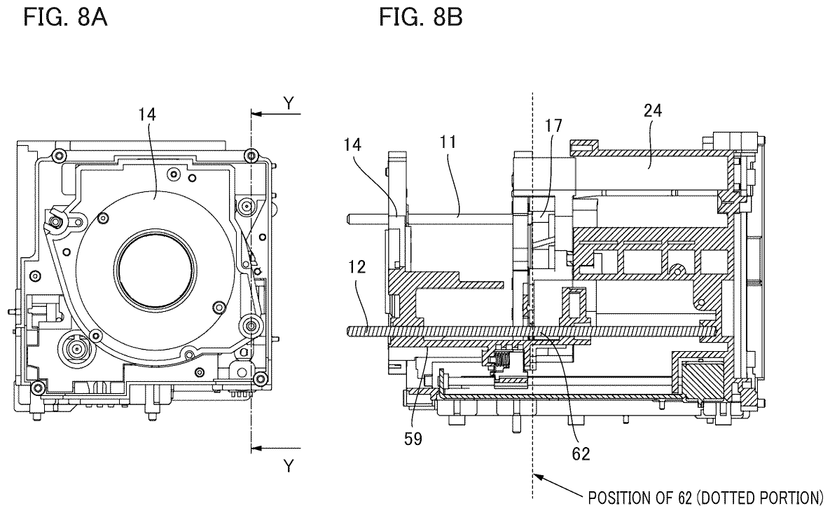

FIG. 8 shows a state where the zoom position of the movable lens frame 14 is at the position of a WIDE end. FIG. 8A is an example of a side view showing a state where the zoom position of the movable lens frame 14 is at the position of the WIDE end. FIG. 8B is a cross-sectional view taken along a line Y-Y in FIG. 8A, and is a diagram of the movable lens frame 14 viewed from an object side in the state of FIG. 8A.

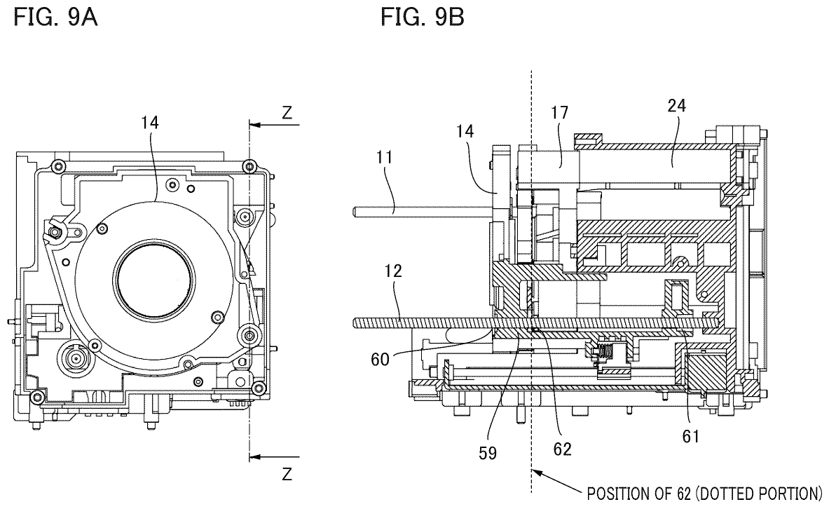

FIG. 9 is a diagram showing a state where the zoom position of the movable lens frame 14 is at the position of a TELE end. FIG. 9A is an example of a side view showing a state where the zoom position of the movable lens frame 14 is at the position of the TELE end. FIG. 9B is a cross-sectional view taken along a line Z-Z in FIG. 9A, and is a diagram of the movable lens frame 14 viewed from an object side in the state of FIG. 9A. The components on the object side which include the front fixed frame 10 are omitted in FIGS. 8 and 9.

In FIG. 8, the zoom position of the movable lens frame 14 engaged with the guide bar 11 and the guide bar 12 is held at the position of the WIDE end. The hole portion 62 of the fixed lens frame 17 inserted into (disposed in) the opening 64 of the sleeve portion 59 of the movable lens frame 14 is fixed to the rear fixed frame 24, and thus the fixed lens frame 17 does not move in the direction of the optical axis OA. Even when the movable lens frame 14 moves in the direction of the optical axis OA, the hole portion 62 of the fixed lens frame 17 is disposed inside the opening 64 of the sleeve portion 59 of the movable lens frame 14, and thus the movable lens frame 14 and the fixed lens frame 17 do not interfere with each other.

In FIG. 9, the zoom position of the movable lens frame 14 engaged with the guide bar 11 and the guide bar 12 is held at the position of the TELE end. The hole portion 62 of the fixed lens frame 17 inserted into (disposed in) the opening 64 of the sleeve portion 59 of the movable lens frame 14 is fixed to the rear fixed frame 24, and thus the fixed lens frame 17 does not move in the direction of the optical axis OA. Even when the movable lens frame 14 moves in the direction of the optical axis OA, the hole portion 62 of the fixed lens frame 17 is disposed inside the opening 64 of the sleeve portion 59 of the movable lens frame 14, and thus the movable lens frame 14 and the fixed lens frame 17 do not interfere with each other.

In this manner, when the movable lens frame 14 moves in the direction of the optical axis OA in accordance with a zoom magnification, the hole portion 62 of the fixed lens frame 17 is already inserted into the opening 64 of the sleeve portion 59 of the movable lens frame 14. That is, since the hole portion 62 of the fixed lens frame 17 is located across the sleeve portion 59 of the movable lens frame 14, interference between the movable lens frame 14 and the fixed lens frame 17 is avoided.

With such a configuration, the efficiency of an arrangement space for members is improved with respect to the external size of the zoom lens barrel 4, and the zoom lens barrel 4 in the present embodiment can be made smaller in the radial direction. As described above, the movable lens frame 14 and the fixed lens frame 17 engage with the guide bar 12, and thus the movable lens frame 14 and the fixed lens frame 17 are positioned in a plane perpendicular to the optical axis OA or in a direction perpendicular to the optical axis OA. For this reason, it is possible to suppress a relative positional deviation between two lens frames (movable lens frame 14, fixed lens frame 17) with the guide bar 12 as a reference.

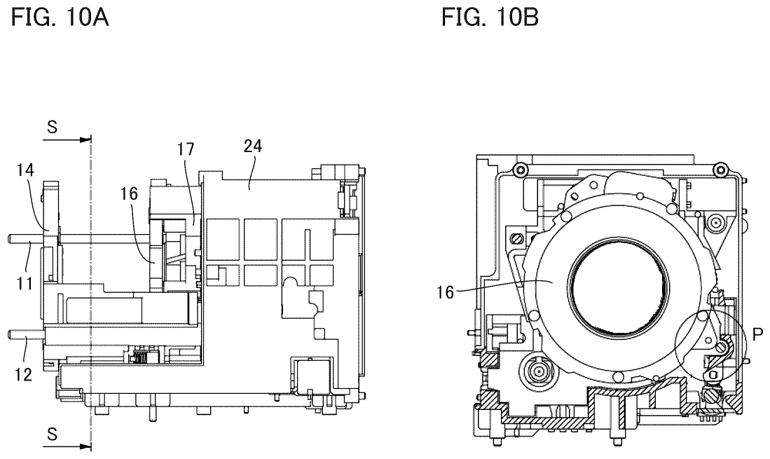

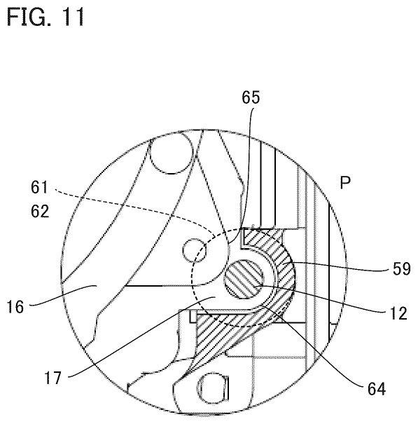

FIG. 10 is a diagram showing a state where the two guide bars, the fixed lens frame 17, the aperture unit 16, and the movable lens frame 14 are incorporated and then inserted into the rear fixed frame 24, and the fixed lens frame 17 is fastened to the rear fixed frame 24. FIG. 10A is a diagram showing a state where the guide bars 11 and 12, the fixed lens frame 17, the aperture unit 16, and the movable lens frame 14 are incorporated into the rear fixed frame 24. The fixed lens frame 17 is fastened to the rear fixed frame 24 with screws (not shown) in FIG. 10. FIG. 10B is a cross-sectional view taken along a line S-S in FIG. 10A, and is a diagram of the movable lens frame 14 viewed from an object side in the state of FIG. 10A. FIG. 11 is a partially enlarged view of P in FIG. 10B.

A portion surrounded by a dotted line in FIG. 11 is an area where there are the first hole portion 60 and the second hole portion 61 through which the guide bar 12 of the movable lens frame 14 passes. As shown in FIG. 11, a part of the outer circumference of an outer portion 65 of the aperture unit 16 is inserted into the opening 64 of the sleeve portion 59 to overlap an area where there are the first hole portion 60 and the second hole portion 61 through which the guide bar 12 of the movable lens frame 14 passes when viewed from the object side in the direction of the optical axis OA.

In this manner, the outer portion 65 of the aperture unit 16 is disposed to be inserted into the opening 64 of the sleeve portion 59 provided in the movable lens frame 14, and thus it is possible to further reduce the size of the zoom lens barrel 4 in the radial direction.

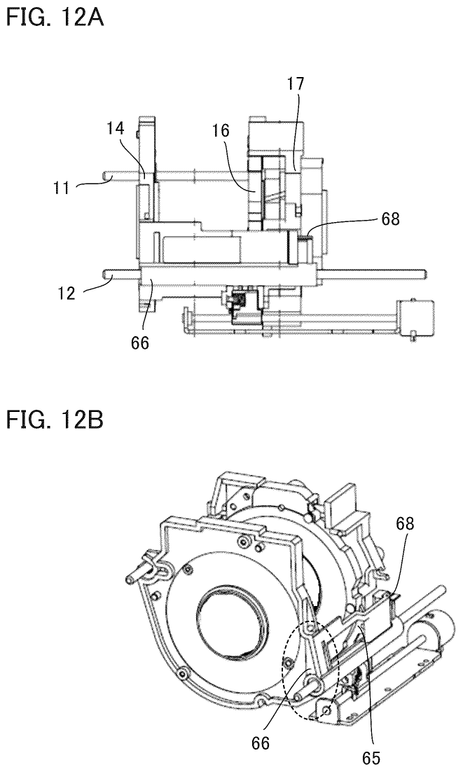

FIG. 12 is a diagram showing a state where the rear fixed frame 24 has been removed from the state shown in FIG. 10. FIG. 12A is an example of a side view showing a state where the rear fixed frame 24 has been removed from FIG. 10A. FIG. 12B is an example of a perspective view (assembly perspective view) of FIG. 12A.

A wall portion 66 provided with the first hole portion 60 through which the guide bar 12 of the movable lens frame 14 passes is indicated by an area of a circle indicated by a dotted line, the area indicating an area equivalent to an extended portion of a lens holding portion that holds the zoom lens 13.

As described above, the zoom lens barrel 4 in the present embodiment includes a photodetector (not shown), such as a photointerrupter, which is held by the rear fixed frame 24. A fin portion (plate portion, light-shielding portion) 68 that shields light emitted from the photodetector is provided in the vicinity of the second hole portion 61 through which the guide bar 12 of the movable lens frame 14 passes.

In the present embodiment, the fin portion 68 is a plate member that shields light emitted from the photodetector. In this manner, the photodetector can detect the position of the movable lens frame 14 using the fin portion 68.

A wall portion 66 (which may be considered as a part of the first hole portion 60) provided with the fin portion 68 and the first hole portion 60 through which the guide bar 12 of the movable lens frame 14 passes is configured to straddle the outer portion 65 of the aperture unit 16. That is, when viewed in a direction perpendicular to the optical axis, the plate portion (fin portion 68) that blocks the photodetector and a part of the hole portion 62 of the fixed lens frame 17 overlap each other.

With the above-described configuration, the efficiency of a space is improved in the radial direction of the zoom lens barrel 4. In this manner, in the present embodiment, both the movable lens frame 14 and the fixed lens frame 17 are positioned in a plane perpendicular to the optical axis OA or in a direction perpendicular to the optical axis with the same guide bar as a reference. Thereby, it is possible to suppress a relative positional deviation between two or more lens frames with the guide bar 12 as a reference while reducing the size of the zoom lens barrel 4 in the radial direction and to provide a high-image-quality zoom lens barrel.

As described above, in the present embodiment, it is possible to provide a zoom lens barrel (lens barrel) that is smaller than lens barrels of the related art and has a structure capable of high-precision lens holding.

Although the preferred embodiments of the present invention has been described above using examples and drawings, the present invention is not limited to these embodiments, and various modifications and changes can be made within the scope of the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-179364, Oct. 18, 2023, which is hereby incorporated by reference wherein in its entirety.

What is claimed is:

1. A lens barrel comprising:
a first lens and a second lens;
a first lens frame that holds the first lens and a second lens frame that holds the second lens; and
a first guide bar that supports the first lens frame so that it is movable in an optical axis direction, wherein
the first lens frame includes a sleeve portion including a first hole portion and a second hole portion that are engaged with the first guide bar and an opening portion formed between the first hole portion and the second hole portion,
the second lens frame is provided with a third hole portion that engages with the first guide bar, and
when the first guide bar is engaged with the first hole portion and the second hole portion of the first lens frame and the third hole portion of the second lens frame, the first lens frame and the second lens frame are positioned in a direction perpendicular to the optical axis by the first guide bar, and the third hole portion of the second lens frame is disposed within the opening of the sleeve portion.

2. The lens barrel according to claim 1, further comprising a second guide bar that regulates rotation of the first lens around the optical axis,
wherein the first lens frame and the second lens frame are positioned by the first guide bar in a state where the rotation around the optical axis is regulated by the second guide bar.

3. The lens barrel according to claim 1, further comprising a second guide bar that regulates the rotation of the first lens around the optical axis, wherein
the second lens frame is provided with a fourth hole portion that engages with the second guide bar, and
the rotation of the second lens frame around the optical axis is regulated by engaging the second guide bar with the fourth hole portion.

4. The lens barrel according to claim 1, wherein, when viewed in the optical axis direction, the first hole portion of the first lens frame overlaps with the second hole portion and the third hole portion of the second lens frame.

5. The lens barrel according to claim 1, wherein
the first hole portion is provided on an imaging surface side of the sleeve portion in the optical axis direction, and
the second hole portion is provided on an object side of the sleeve portion in the optical axis direction.

6. The lens barrel according to claim 1, further comprising:
a second guide bar that regulates the rotation of the first lens around the optical axis; and
a fixed frame that holds the first guide bar and the second guide bar.

7. The lens barrel according to claim 1, further comprising an aperture unit that is fixed to the second lens frame,
wherein a part of the aperture unit is inserted into the opening when the first guide bar is engaged with the first and second hole portions of the first lens frame and the third hole portion of the second lens frame.

8. The lens barrel according to claim 1, further comprising a photodetector that detects the position of the first lens frame,
wherein the first lens frame is provided with a light-shielding portion that shields light from the photodetector.

9. The lens barrel according to claim 8, wherein the light-shielding portion overlaps a part of the third hole portion when viewed in a direction perpendicular to the optical axis.

10. An image capturing apparatus comprising:
an image sensor; and
the lens barrel according to claim 1.
